(19) United States
(12) Patent Application Publication
(10) Pub. No.: US 2014/0257971 A1
(43) Pub. Date: Sep. 11, 2014

(54) CLOUD-BASED CAMPAIGN CONTROL SYSTEM AND METHOD

(71) Applicant: Daniel Frankfort, Chicago, IL (US)

(72) Inventor: Daniel Frankfort, Chicago, IL (US)

(21) Appl. No.: 13/786,468

(22) Filed: Mar. 6, 2013

(51) Int. Cl. G06Q 30/02

(52) U.S. Cl. CPC G06Q 30/0242
USPC 705/14.43; 705/14.45; 705/14.66

(57) ABSTRACT

Disclosed are various embodiments of a system and a method for conducting cloud-based commerce. In accordance with one aspect of the approach, a method of cloud-based commerce, the method may include the steps of receiving a plurality of campaign instructions from a plurality of campaign controllers, configuring the campaign instructions and creating a unique brand identifier, campaign data, and a distribution trigger, the campaign data including a brand communication message and a redemption offer, distributing the campaign data to a plurality of mobile computer devices, causing the display of the brand communication message upon a first of the mobile computer devices, authorizing redistribution of the campaign data to a second of the mobile communication devices, acknowledging the acceptance of the redemption offer, creating analytics data based upon the campaign data, distribution data, and redemption data.

### BACKGROUND

1. Field

This invention is generally related to electronic commerce, and in particular, to a system and method for conducting cloud-based commerce.

2. Background

Various methods and systems related to conducting cloud-based commerce are known in to those having ordinary skill in the art. However, the known systems and methods are not optimal for conducting cloud-based commerce.

### SUMMARY

Disclosed herein is a new and improved system and method for conducting cloud-based commerce. In accordance with one aspect of the approach, a method of cloud-based commerce, the method may include the steps of receiving a plurality of campaign instructions from a plurality of campaign controllers, configuring the campaign instructions and creating a unique brand identifier, campaign data, and a distribution trigger, the campaign data including a brand communication message and a redemption offer, distributing the campaign data to a plurality of mobile computer devices, causing the display of the brand communication message upon a first of the mobile computer devices, authorizing redistribution of the campaign data to a second of the mobile communication devices, acknowledging the acceptance of the redemption offer, creating analytics data based upon the campaign data, distribution data, and redemption data.

Other systems, methods, aspects, features, embodiments and advantages of the system and method for cloud-based campaign control disclosed herein will be, or will become, apparent to one having ordinary skill in the art upon examination of the following drawings and detailed description. It is intended that all such additional systems, methods, aspects, features, embodiments and advantages be included within this description, and be within the scope of the accompanying claims.

### BRIEF DESCRIPTION OF THE DRAWINGS

Many aspects of the present disclosure can be better understood with reference to the following drawings. It is to be understood that the drawings are solely for purpose of illustration. Furthermore, the components in the figures are not necessarily to scale, emphasis instead being placed upon clearly illustrating the principles of the system and method disclosed herein. In the figures, like reference numerals designate corresponding parts throughout the different views.

FIG. 1 is a drawing of a networked environment according to various embodiments of the present disclosure.

FIG. 2 is a flowchart illustrating one example of the functionality implemented as portions of the cloud-based commerce system executed in one or more of the computing device in the networked environment of FIG. 1 according to various embodiments of the present disclosure.

FIG. 3 is a flowchart illustrating one example of the functionality implemented as portions of the cloud-based commerce system executed in one or more of the computing device in the networked environment of FIG. 1 according to various embodiments of the present disclosure.

FIG. 4 is a flowchart illustrating one example of the functionality implemented as portions of the cloud-based commerce system executed in one or more of the computing device in the networked environment of FIG. 1 according to various embodiments of the present disclosure.

FIG. 5 is a flowchart illustrating one example of the functionality implemented as portions of the cloud-based commerce system executed in one or more of the computing device in the networked environment of FIG. 1 according to various embodiments of the present disclosure.

FIG. 6 is a flowchart illustrating one example of the functionality implemented as portions of the cloud-based commerce system executed in one or more of the computing device in the networked environment of FIG. 1 according to various embodiments of the present disclosure.

FIG. 7 is a flowchart illustrating one example of the functionality implemented as portions of the cloud-based commerce system executed in one or more of the computing device in the networked environment of FIG. 1 according to various embodiments of the present disclosure.

### DETAILED DESCRIPTION

The following detailed description, which references to and incorporates the drawings, describes and illustrates one or more specific embodiments. These embodiments, offered not to limit but only to exemplify and teach, are shown and described in sufficient detail to enable those skilled in the art to practice what is claimed. Thus, for the sake of brevity, the description may omit certain information known to those of skill in the art.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied on any tangible medium of expression having computer-usable program code embodied in the medium.

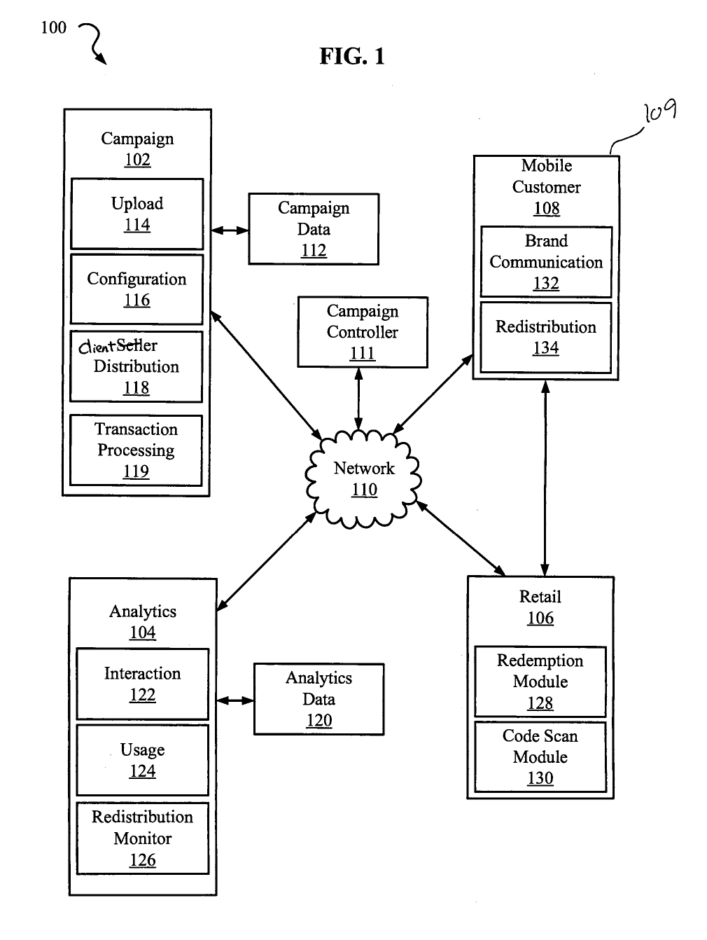

With reference to FIG. 1, shown is a networked environment 100 according to various embodiments. The networked environment 100 includes one or more cloud-based campaign computing devices 102, one or more cloud-based analytics computing devices 104, one or more retail execution computing devices 106, a plurality of mobile customer computing devices 108, and a campaign controller 111, each of which is coupled to a network 110. The network 110 may be, for example, the Internet, intranets, extranets, wide area networks (WANs), local area networks (LAN s), wired networks, wireless networks, or other suitable networks, etc., or any combination of two or more such networks.

The cloud-based campaign computing device(s) 102 may comprise, for example, a server computer or any other system providing computing capability. Alternatively, a plurality of campaign computing devices 102 may be employed that are arranged, for example, in one or more server banks or computer banks or other arrangements. For example, a plurality of campaign computing devices 102 together may comprise, for example, a cloud computing resource, a grid computing resource, and/or any other distributed computing arrangement. Such campaign computing devices 102 may be located in a single installation or may be dispersed among many different geographical locations. In one embodiment, the campaign computing device 102 represents a virtualized computer system executing on one or more physical computing systems. For purposes of convenience, the campaign computing device 102 is referred to herein in the singular. Even though the campaign computing device 102 is referred to in the singular, it is understood that a plurality of campaign computing devices 102 may be employed in the various arrangements as described above.

Campaign controller 111 is representative of a plurality of campaign controllers that may be located at various locations and all of which may be able to provide campaign instructions to the campaign computing device 102.

Various applications and/or other functionality may be executed in the campaign computing devices 102 according to various embodiments. Also, various data is stored in a campaign data store 112 that is accessible to the campaign computing device 102. The campaign portal data store 112 may be representative of a plurality of data stores 112 as can be appreciated. The data stored in the campaign data store 112, for example, is associated with the operation of the various applications and/or functional entities described below. The data store may include segregating features to provide separate storage for a plurality of campaign controllers 111 and security features for preventing access by third party campaign controllers 111.

The components executed on the campaign computing device 102 may include, for example, a client upload module 114, a client configuration module 116, a client distribute module 118, a transaction processing module 119, and other systems, applications, services, processes, engines, or functionality not discussed in detail herein.

The cloud-based analytics computing device(s) 104 may comprise, for example, a server computer or any other system providing computing capability. Alternatively, a plurality of analytics computing devices 104 may be employed that are arranged, for example, in one or more server banks or computer banks or other arrangements. For example, a plurality of analytics computing devices 104 together may comprise, for example, a cloud computing resource, a grid computing resource, and/or any other distributed computing arrangement. Such analytics computing devices 104 may be located in a single installation or may be dispersed among many different geographical locations. In one embodiment, the analytics computing device 104 represents a virtualized computer system executing on one or more physical computing systems. For purposes of convenience, the analytics computing device 104 is referred to herein in the singular. Even though the analytics computing device 104 is referred to in the singular, it is understood that a plurality of analytics computing devices 104 may be employed in the various arrangements as described above.

Various applications and/or other functionality may be executed in the analytics computing devices 104 according to various embodiments. Also, various data is stored in an analytics data store 120 that is accessible to the analytics computing device 104. The analytics data store 120 may be representative of a plurality of analytics data stores 120 as can be appreciated. The data stored in the analytics data store 120, for example, is associated with the operation of the various applications and/or functional entities described below.

The components executed on the analytics computing device 104 may include, for example, a customer interaction module 122, a customer promotion usage module 124, a redistribution monitor module 126, and other systems, applications, services, processes, engines, or functionality not discussed in detail herein.

The retail execution computing device(s) 106 may comprise, for example, a processor based system such as a computerized cash register, a laptop computer, a personal digital assistant, a cellular telephone, a smart phone and computing devices associated with cash registers.

The components executed on the retail execution computing device(s) 106 may include, for example, a digital key redemption module 128, a code scan module 130, and other systems, applications, services, processes, engines, or functionality not discussed in detail herein.

The mobile customer computing device(s) 108 may comprise, for example, a mobile processor based system such as a mobile phone system. Such a computer system may be embodied in the form of a laptop computer, a personal digital assistant, a cellular telephone, a cash register, and computing devices associated with cash registers.

The components executed on the mobile customer computing device(s) 108 may include, for example, a brand communication module 132, a redistribution module 134, and other systems, applications, services, processes, engines, or functionality not discussed in detail herein. The components may be downloadable from, for example, the campaign computer device 102 via the network 110.

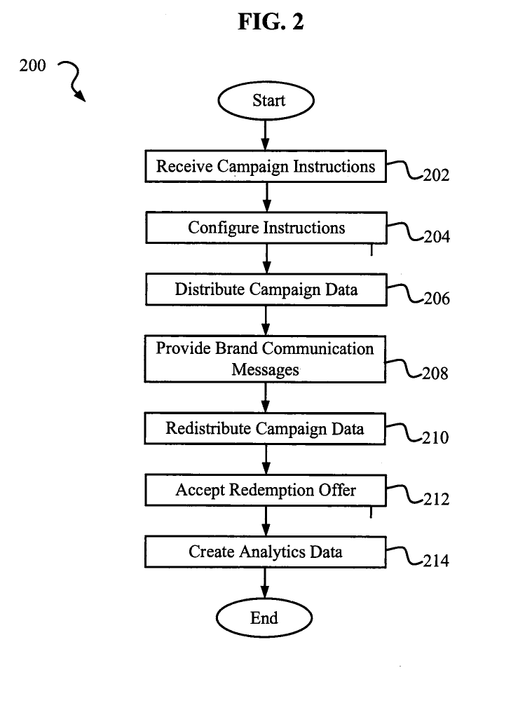

FIG. 2 shows a flowchart 200 illustrating one example of functionality that may be implemented as portions of a cloud-based commerce system executed in at least one computing device in a networked environment according to various embodiments of the present disclosure. In one embodiment, flowchart 200 illustrates the functionality that may be implemented as portions of a cloud-based commerce system executed in at least one computing device, such as the campaign computing device 102, in a networked environment, such as network 110, according to various embodiments of the present disclosure. Flowchart 200 provides merely an example of the many different types of functional arrangements that may be employed to implement the operation of the depicted functionality of the cloud-based commerce system as described herein. As an alternative, the flowchart 200 may be viewed as depicting an example of steps of a method implemented in the network 110 according to one or more embodiments.

Beginning with block 202 of FIG. 2, a cloud-based campaign computing devices may receive campaign instructions. For example, the campaign computing device 102, may receive campaign instructions from the campaign controller 111. The campaign instructions may be received using, for example, a client upload module, and the campaign computing device may receive campaign instructions using, for example, a web browser. For example, a campaign computing device 102 may receive campaign instructions from the campaign controller 111 using the client upload module 114 via network 110. The campaign controller 111 may use a web browser associated with the campaign controller 111 to communicate with the campaign computing device 102. The campaign computing device 102 may allow secure HTTPS web based access to self-service web portal. Receiving campaign instructions of block 202 may include modules for allowing access to the campaign computing device, for example login access, selection of campaign brand, access to previous campaign data, campaign content upload, campaign content display, and distribution rules. Receiving campaign instructions of block 202 may also include modules for specification of distribution methods, specification of campaign data, for accepting offers, and for activating a campaign.

In block 204, the campaign instructions may be configured to create campaign data. For example, the campaign instructions may be configured using the client configuration module 116. Client configuration module 116 may allow for campaign instructions to be specific to one of a plurality of brands associated with a campaign controller 111. A brand identifier may include data related to the campaign controller, one or more controller brands. The campaign instructions may include providing a unique campaign controller configuration that provides a controller specific look & feel, including associated access rules & policies. The configuring of campaign instructions of block 204 may include creating campaign metadata based on campaign content and campaign definitions and rules and a campaign distribution trigger. For example, a brand identifier may include data related to the campaign controller 111 and one or more controller brands associated with campaign controller 111. The configuration of block 204 may include creating a unique campaign controller configuration that provides a controller specific look & feel, including associated access rules & policies. The configuring of campaign instructions of block 204 may include modules for creating a campaign communication message, campaign metadata based on campaign content and campaign definitions and rules and a campaign distribution trigger.

In block 206, the campaign data may be distributed. Campaign data may be distributed in a variety of manners, including but not limited to, emails, texts, twitter, face book, and BB messenger. The campaign data may be distributed in a blast distribution or in a targeted manner by, for example, distributing the campaign in a plurality of languages based on geography, geo encoding, time period, user data, loyalty level, demographics, distributing for a single distribution or multiple distributions, customer actions, and distributing the campaign data to mobile customer devices when the mobile customer devices in the vicinity of retail computing devices, and/or other geographic information. For example, the campaign data may be generated based, in part, upon the campaign instructions, and may be distributed using client distribution module 118. Campaign data may include, for example, digital key pairing, QR codes, ringtones, music, campaign event information, discounts, brand promotion offers, complementary product information, surveys, brand videos and other media forms. For example, the campaign data may be distributed to a plurality of mobile computing devices 108 via network 110. Mobile customer computing device 108 may include means for logging into a cloud-based commerce system application, such as campaign computing device 102. The campaign data distribution of block 206 may include use of mobile customer computing device 108 modules for allowing a download of the campaign data, identification of social media credentials, and registration. Distributing campaign data may also include confirming customer identification, retrieving a customer profile from the campaign database 112, evaluating customer profile based on campaign rules. The campaign data distribution of block 206 may also include use of campaign computing device 102 modules for accessing data associated with the mobile customer device 108 and/or the user of the mobile customer device 108, creating a customer profile, and confirming customer credentials.

In block 208, one or more brand communication messages may be made available to a plurality of mobile communication devices. The brand communication messages may include one or more redemption offers, one or more scannable marks, a push notification, etc. The brand communication messages may include content, including texts and videos, that may read and viewed via display devices (not shown) associated with the mobile communication device. The brand communication messages may include rewards that may be earned based on desired responses to the brand communication data, such as redemptions, redistributions, creating testimonials, reading text, watching videos, answering trivia questions, completing surveys, interactions with retail execution computing devices, third parties acting upon redistributed brand communication data, etc. For example, one or more brand communications messages may be generated based on campaign data in the brand communication module 132 of one or more customer computing devices 108.

In block 210, campaign data may be redistributed. For example, one or more brand communications messages may be redistributed from a first brand communication module 132 of a first customer computing devices 108 to one or more additional brand communication modules 132 of additional customer computing devices 108 via network 110. Redistribution may be done in a variety of manners, including but not limited to, emails texts, twitter, facebook, google+, and BB messenger. The redistribution of block 210 may include accepting a share application input from the mobile communication device 108 which may include information regarding a method of redistribution and identification of target for redistribution.

In block 212, a redemption offer may be accepted. For example, the retail execution computing device 106 may use the code scan module 130 to read a scannable mark from a mobile customer device 108 and a sale may be accepted at the retail execution computing device 106 using the redemption module 128. In some embodiments, the mobile customer device 108 may include a means for accepting a touch screen trigger to accept a digital key. The scannable mark may be a barcode and/or a Quick Response Code (QR). The retail execution computing device 106 may include a database of valid QR codes. The campaign computing device may provide instructions to the retail execution computing device, via network 110, for acknowledging and recording the acceptance of the redemption offer.

In block 214, analytics data may be created. For example, the analytics computing device 104 may use campaign data, distribution data, and redemption data to create analytics data that may be stored in, for example, analytics data store 120. Analytics data may include customer interaction data, customer promotion data, loyalty data, and redistribution monitoring and redistribution method data. Analytics data may include information related to identification of customer, identification of products, customer location, locations of customers in relation to products, heat maps, historical campaign data, and data related to how a customer is interacting with the products, for example, customer Bob John used a coupon for 6 pack of Pepsi in Coral Gables, Miami, Fla. 33114 at 2:15 p.m. on Saturday Jan. 4, 2013. This data may be useful in determining customer motivation. For example, analytics data may include data generated by the customer interaction module 122, the customer promotion usage module 124, and the redistribution monitor module 126.

The computing devices 102, 104, 106 and 108 includes at least one processor circuit (not shown) and a memory (not shown), both of which are coupled to a local interface (not shown). The local interface may comprise, for example, a data bus with an accompanying address/control bus or other bus structure as can be appreciated. The computing devices may be desktops, mobile devices, servers, and other computer based devices.

Stored in the memory are both data and several components that are executable by the processor. In particular, in regard to the campaign computing devices 102, stored in the memory and executable by the processor are one or more modules associated with the cloud-based commerce system of flowchart 200, and potentially other applications. In addition, an operating system may be stored in the memory and executable by the processor.

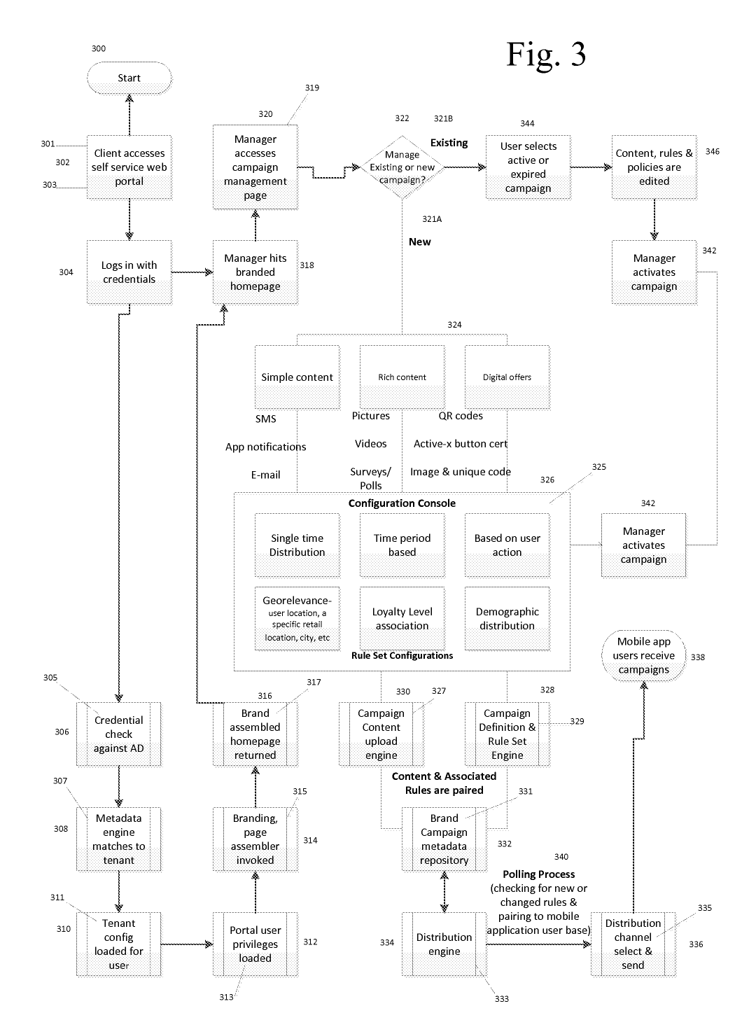

FIG. 3 is a flow chart illustrating one example of functionality that may be implemented as portions of a cloud-based commerce system executed in at least one computing device in a networked environment according to various embodiments of the present disclosure. In block 302, a client 301, who may be a corporate client, may access a self-service web portal 303. In block 304, the login credentials may be checked against referenced credentials 305.

In block 308, if login credentials are verified then metadata engine 307 may match to client. In block 310, client configuration 311 may be loaded. In block 312, portal user privileges 313 may be loaded. In block 314, client page assembler 315 may be invoked. In block 316, client assembled homepage 317 may be returned. In block 318, client may accordingly access customized homepage 317. In block 320, client may also access campaign management page 319.

In block 322, client may manage new campaign 321A or existing campaign 321B. In block 324, new campaign 321A may include simple content including sms, electronic messaging, application notifications and so forth, rich content may include pictures, videos, surveys, polls and so forth, and/or digital offers including QR codes, active-X button cert, image and unique code and so forth. In block 326, configuration module 325 allow client to set rules of distribution of content based on variety of variables, such as time, geographic location, end user's behavior, geo-relevance including end user's location in specific retail location in specific city or town and so forth, loyalty level of end user, demographic distribution of end user, and so forth. Said variables may include any set of unique identifications of end users, such as race, sex, age, location, credit history, purchase history, social network activity and so forth.

In block 330, campaign content upload engine 327 may be set. In block 328, campaign definition and rule set 329 engine may be configured. In block 332, content and rules are paired creating campaign metadata depository 331. In block 334, a content distribution engine 333 may be configured. Process 340 may continuously check for new and/or changed rules and pair them to end user 109.

In block 336, distribution channels 335 may be selected and set. In block 338 or 342, client may activate campaign causing data to be sent to end user 109. In block 344, for existing campaign 321B, client may edit rules of distribution module 326 and/or content module 324.

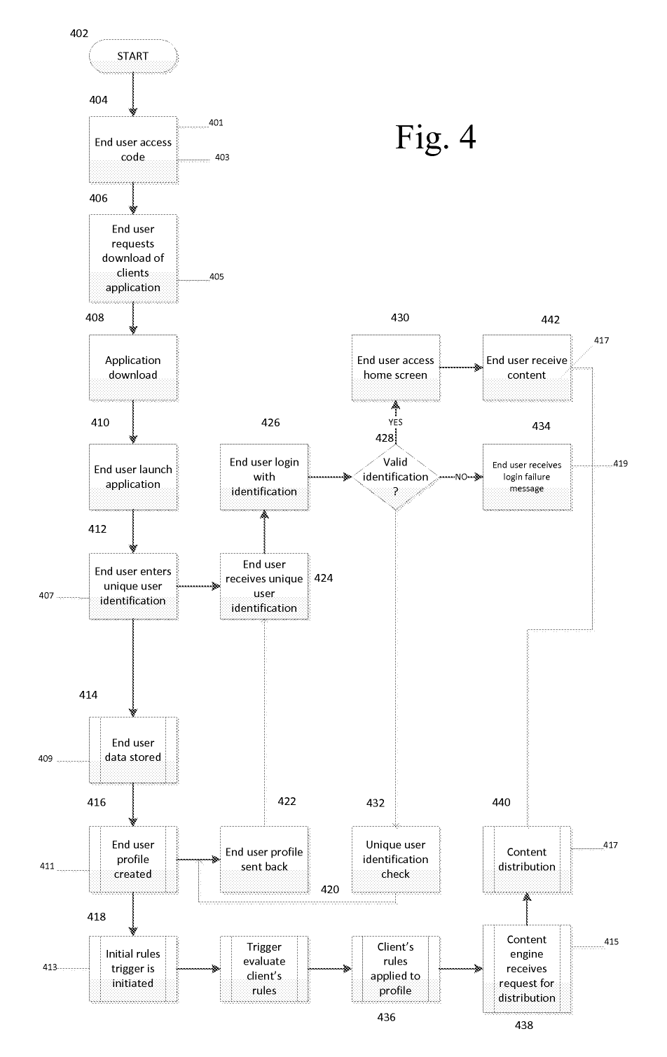

FIG. 4 is a flowchart illustrating one example of functionality that may be implemented as portions of a cloud-based commerce system executed in at least one computing device in a networked environment according to various embodiments of the present disclosure. In block 404, end user 109 may access code 401 on a communication device 403. In block 406, end user may request download of client's application 405 on communication device 403. In block 408, application may be downloaded. In block 410, end user 109 may launch application 405. In block 412, end user 109 may enter his unique user identification 407, which may include certain variables uniquely identifying end user 109. In block 414, end user data 409 may be stored. In block 416, end user profile 411 may be created. In block 422, end user profile 411 may be sent back. In block 424, end user 109 may receive unique user identification 407. In block 426, end user 109 may login with identification 407. In block 428, identification is verified.

In block 432, unique user identification 407 is checked against end user profile 411 in block 416. If identification is valid then initial rules trigger 413 may be initiated as in block 418. In block 420, trigger 413 may evaluate client rules module 326. In block 436, client rules module 326 may be applied to profile 411 of end user 109. In block 438, content engine 415 may receive requests for distribution. In block 440, content 417 may be distributed. In block 442, end user 109 may receive distributed content 417. If identification is not valid, then end user 109 may receive login failure message 419 as in block 434.

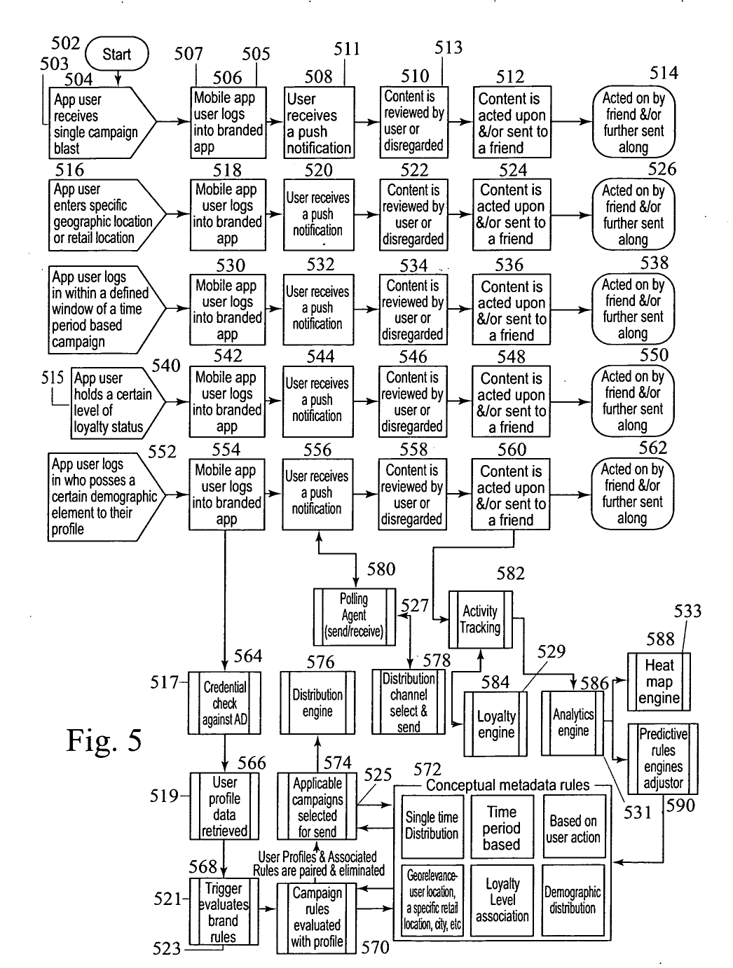

FIG. 5 is a flowchart illustrating one example of functionality that may be implemented as portions of a cloud-based commerce system executed in at least one computing device in a networked environment according to various embodiments of the present disclosure.

In block 504, end user 109 may receive single campaign communication 503. In block 506, end user 109 may log into application 505 via communication device 507. In block 508, end user 109 may receive a push notification 511. In block 510, end user may review or disregard received content 513. In block 512, end user 109 may act on content or send content to a friend. In block 514, content may be acted on by friend and/or shared with others. In block 516, end user 109 may enter specific geographic location or retail location. In block 518, end user 109 may log into mobile application 505. In block 520, end user 109 may receive push notification 511. In block 522, content may be reviewed by, used or disregarded by end user 109. In block 524, content may be acted upon or sent to a friend. In block 526, content may be acted on by friend or shared with others. In block 528, end user 109 may login within a defined time window period based on advertising campaign. In block 530, end user may log into mobile application 505. In block 532, end user 109 may receive push notification 511. In block 534, content may be reviewed by, used or disregarded by end user 109. In block 536, content may be acted upon or shared with others. In block 538, content may be acted upon by friend or shared with others. In block 540, end user may 109 hold certain level of loyalty status 515 to certain product. In block 542, end user 109 may log into mobile application 505. In block 544, end user 109 may receive push notification 511. In block 546, content may be reviewed by end user or disregarded. In block 548, content may be acted upon and/or shared with others. In block 550, content may be acted upon with friend or shared with others.

In block 552, end user 109 may be characterized by certain demographic features may login into mobile application 505. In block 554, end user 109 may log into mobile application 505. In block 564, credentials of end user 109 may be checked against stored credentials 517. In block 566, end user profile 519 may be retrieved. In block 568, trigger 521 may evaluate client rules module 523. In block 570, campaign rules module 523 may be evaluated in view of profile 519 of end user 109. Profile 519 of end user 109 and associated rules 523 may be paired and/or adjusted with campaign rules module 572. Module 572 may include content distribution rules triggered by single time distribution, time window, end user's actions, geo-relevance, such as location of end user, retail location, city location and so forth. In block 574, applicable campaigns and applicable rules may be sent to distribution engine 525. Distribution channels 527 are selected and used in block 578 to send content to end user 109. In block 558, content may be reviewed by, used or disregarded by end user 109. Content may be acted upon and/or sent to a friend in block 560. The activity of end user 109 is tracked to find out who acted on any campaign, location of said end users, social connections of end user, in block 582. The information is sent to loyalty engine 529 in block 584 and analytics engine 531 in block 586. Analytic information is sent to heat map engine 533 in block 588 to draw patterns of consumer behavior. Analytic information may also be sent to block 590 to adjust predictive rules to improve accuracy of prediction of end user 109 shopping behavior.

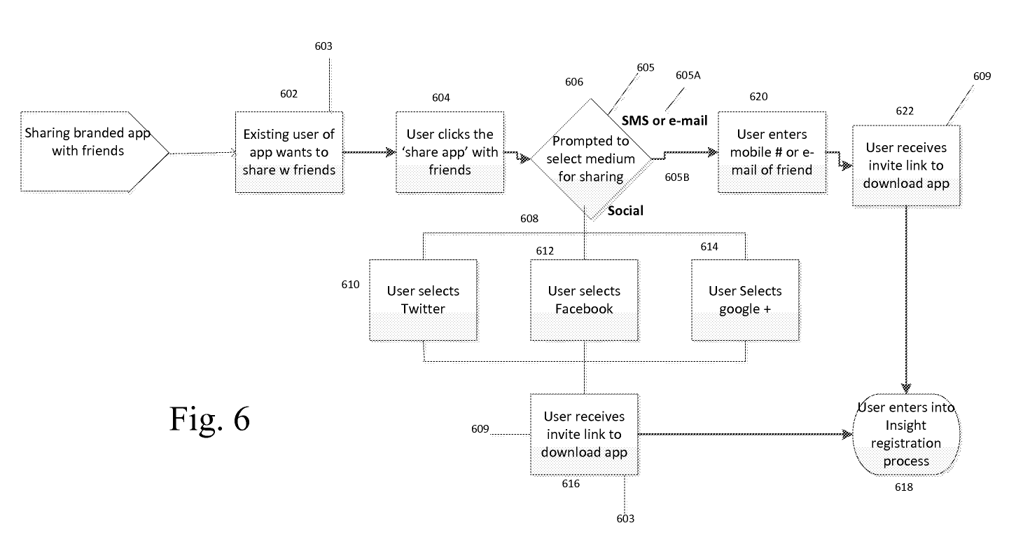

FIG. 6 is a flow chart illustrating one example of functionality that may be implemented as portions of a cloud-based commerce system executed in at least one computing device in a networked environment according to various embodiments of the present disclosure. In block 602, end user 109 may want to share mobile application 603 with friends. In block 602, end user 109 may click “share app” with friends. In block 606, end user 109 may be prompted to select medium 605 for sharing, such as, SMS/Email 605A or social media 605B. In block 608, end user 109 may select social media 608 such as twitter 610, social networks such as Facebook 612 and/or Google+614. End user 109 may receive invite link 609 to download applications 603 prompting end user 109 to repeat registration steps, as in FIG. 4. End user 109 may enter mobile telephone number or electronic email of a friend in block 620. End user 109 may receive invite link 609 to download application in block 622. End user 109 may repeat registration steps as in FIG. 4.

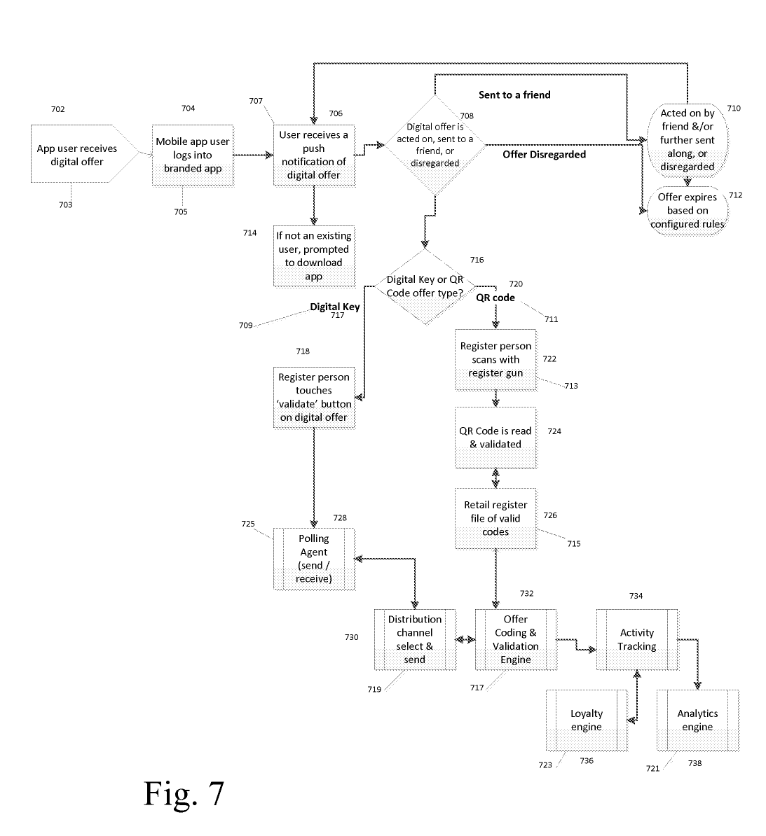

FIG. 7 is a flow chart illustrating one example of functionality that may be implemented as portions of a cloud-based commerce system executed in at least one computing device in a networked environment according to various embodiments of the present disclosure. In block 702, end user 109 may receive digital offer 703. End user 109 may log into mobile application 705 in block 704. End user 109 may receive push notification 707 of digital offer in block 706. If end user 109 is not an existing user, end user 109 may be prompted to download mobile application 705 as in block 714. Digital offer 703 may be acted on, sent to a friend or disregarded in block 708. In block 710, a friend may act upon content, and/or further share content with others. If offer is disregarded, offer expires based on configured rules in block 712.

End user 109 is prompted to choose between digital key 709 or QR code 711 offer type in block 716. End user 109 may touch “validate offer” on digital offer 703 in block 718. End user 109 may chose QR code 711 as in block 720. End user 109 may scan QR 711 code as in block 722. QR code 711 may be read and validated in any retail place as in block 724. In block 726, retail register file 715 includes database of valid codes 711. Block 726 is in communication with offer coding and validation engine 717 in block 732. Block 732 may be in communication with distribution channels 719 to be selected in block 730. Blocks 732 and 730 may be in communication with block 738 gathering data for analytics engine 721 and/or loyalty engine 723 in block 736. Block 730 of distribution channels 719 may be in communication with polling agent 725 in block 728 to send and receive content.

It is understood that there may be other applications that are stored in the memory and are executable by the processor as can be appreciated. Where any component discussed herein is implemented in the form of software, anyone of a number of programming languages may be employed such as, for example, C, C++, C#, Objective C, Java, Java Script, Perl, PHP, Visual Basic, Python, Ruby, Delphi, Flash, or other programming languages.

A number of software components are stored in the memory and are executable by the processor. In this respect, the term “executable” means a program file that is in a form that can ultimately be run by the processor. Examples of executable programs may be, for example, a compiled program that can be translated into machine code in a format that can be loaded into a random access portion of the memory and run by the processor, source code that may be expressed in proper format such as object code that is capable of being loaded into a random access portion of the memory and executed by the processor, or source code that may be interpreted by another executable program to generate instructions in a random access portion of the memory to be executed by the processor, etc. An executable program may be stored in any portion or component of the memory including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory is defined herein as including both volatile and nonvolatile memory and data storage components. Volatile components are those that do not retain data values upon loss of power. Nonvolatile components are those that retain data upon a loss of power. Thus, the memory may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Also, the processor may represent multiple processors and the memory may represent multiple memories that operate in parallel processing circuits, respectively. In such a case, the local interface may be an appropriate network that facilitates communication between any two of the multiple processors, between any processor and any of the memories, or between any two of the memories, etc. The local interface may comprise additional systems designed to coordinate this communication, including, for example, performing load balancing. The processor may be of electrical or of some other available construction.

Although the cloud-based commerce system, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs anyone of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Flowcharts described herein show the functionality and operation of an implementation of portions of the cloud-based commerce system. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor in a computer system or other system. The machine code may be converted from the source code, etc. If embodied in hardware, each block may represent a circuit or a number of interconnected circuits to implement the specified logical function(s).

Although flowchart described herein show a specific order of execution, it is understood that the order of execution may differ from that which is depicted. For example, the order of execution of two or more blocks may be scrambled relative to the order shown. Also, two or more blocks shown in succession in flowcharts may be executed concurrently or with partial concurrence. Further, in some embodiments, one or more of the blocks shown in flowcharts may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Flowcharts and block diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

Also, any logic or application described herein, including the electronic cloud-based commerce system, that comprises software or code can be embodied in any non-transitory computer-readable medium for use by or in connection with an instruction execution system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise anyone of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

The word “exemplary” is used herein to mean “serving as an example, instance, or illustration.” Any embodiment or variant described herein as “exemplary” is not necessarily to be construed as preferred or advantageous over other embodiments or variants. All of the embodiments and variants described in this description are exemplary embodiments and variants provided to enable persons skilled in the art to make and use the invention, and not necessarily to limit the scope of legal protection afforded the appended claims.

The above description of the disclosed embodiments is provided to enable any person skilled in the art to make or use that, which is defined by the appended claims. The following claims are not intended to be limited to the disclosed embodiments. Other embodiments and modifications will readily occur to those of ordinary skill in the art in view of these teachings. Therefore, the following claims are intended to cover all such embodiments and modifications when viewed in conjunction with the above specification and accompanying drawings. All such modifications and variations are intended to be included herein within the scope of this disclosure and protected by the following claims.

What is claimed is:

1. A non-transitory computer-readable medium embodying a program executable in at least one cloud-based computing device, the program comprising: code that receives a plurality of campaign instructions from a plurality of campaign controllers; code that configures the campaign instructions and creates a unique brand identifier, campaign data, and a distribution trigger, the campaign data including a brand communication message and a redemption offer; code that distributes the campaign data to a plurality of mobile computer devices; code that causes the display of the brand communication message upon a first of the mobile computer devices; code that authorizes redistribution of the campaign data to a second of the mobile communication devices; code that acknowledges the acceptance of the redemption offer; and code that creates analytics data based upon the campaign data, distribution data, and redemption data.

2. A computer implemented method comprising: receiving login unique user identification; verifying said unique user identification; uploading unique content matching said unique user identification; uploading portal user privileges; invoking unique content page assembler; returning unique content assembled homepage;
authorizing access to a content management module, wherein said content management module comprises rules for distribution of said content; said content comprises simple content, rich content, digital offers, SMS, application notifications, electronic communication, images, videos, surveys, polls, digital codes; authorizing access to configuration module, said configuration module comprises single time distribution, time sensitive distribution, geographically relevant distribution, distribution channels, loyalty level distribution, and demographic distribution; uploading unique content campaign engine; setting unique content rules and definition engine; and setting unique content metadata repository.

3. The method of claim 2 further comprising creating mobile application adapted to be configured on communication devices.

4. The method of claim 2 further comprising accessing said mobile application on said communication device.

5. The method of claim 2 further comprising obtaining unique user identification data.

6. The method of claim 5 further comprising associating said unique user identification data with said communication device.

7. The method of claim 6 further comprising causing said configuration module to send content to said unique end user.

8. A computer implemented method comprising: receiving digital content at a web based portal, said digital content including a set of rules for managing and distributing said digital content, wherein said portal resides on a server; distributing said digital content based on said rules to a processing device; receiving from said device identifying data of a user of said communication device; if said identifying date has been previously received, determining a unique user identifier associated with said user from said identifying date; if said identifying data has not been previously received, determining a unique user identifier associated with said user; associating said identifying information with said unique user identifier on one or more databases; generating information tracking said unique user identifier; and associating said information with said unique user identifier on said one or more databases; configuring said digital content based on said information; and distributing said configured digital content to said unique user identifier.
